(19) United States
(12) Patent Application Publication
(10) Pub. No.: US 2007/0001067 A1
(43) Pub. Date: Jan. 4, 2007

(54) Sanitary fittings with single hole fastening

(76) Inventor: Albert Becker, Wittlich (DE)

Correspondence Address: AMERICAN STANDARD INC., ONE CENTENNIAL AVENUE, PISCATAWAY, NJ, 08855-6820, US

(21) Appl. No.: 11/447,420

(22) Filed: Jun. 6, 2006

(30) Foreign Application Priority Data
Dec. 12, 2003 (DE) 103 58 132.4
Dec. 8, 2004 (WO) PCT/EP04/13919

(51) Int. Cl. F16L 3/00

(52) U.S. Cl. 248/121

(57) ABSTRACT

A sanitary stand fitting for fixing in a receiving hole of a fitting support, such as that of a sanitary appliance such as a wash-stand or sink or the like, or other support plate with a fixing anchor movably supported on the fitting body, which anchor, when the fitting body is assembled, can be brought into a position flush with the receiving hole of the fitting support, and can be guided through the receiving hole and automatically assumes a locked position after passing through the receiving hole, and with a clamping device by means of which the fitting body and the fixing anchor, in its locked position, are clamped against each other, characterised in that the fixing anchor (12) is retained on the fitting body (10) by means of an elongated flexible spring (11) having a greater length than the material thickness of the fitting support (16), and in that a threaded rod (14), as a clamping device, can be passed through a hole (13) formed in the fitting body (10) and can be screwed into a threaded hole formed on the fixing anchor with a thread formed at its end.

### SPECIFICATION

The invention relates to sanitary stand fittings for fixing in a receiving hole of a fitting support, such as that of a sanitary installation such as wash-stand or sink or the like, or other support plate with a fixing anchor movably secured to the fitting body, which anchor can be brought into a position flush with the receiving hole of the fitting support when the fitting body is assembled and can be guided through the receiving hole, automatically assuming a locked position after passing through the receiving hole, and with a clamping device by means of which the fitting body and the fixing anchor in its locked position can be clamped one against the other.

If it is important, when assembling a stand fitting on a fitting support, for the assembly to be carried out only from the top of the fitting support, and hence from the side of erection of the standing fitting, the generic publication DE 93 05 113 A1 proposes providing a tie bolt in one hole of the fitting body, with a clamping nut supported by it, wherein a fixing anchor is rotatably arranged on the clamping nut and is articulated so that it automatically swivels from an assembly position to a locked position. This is achieved, for example, in that the fixing anchor is articulated to the clamping nut so that its centre of gravity lies eccentrically to its fulcrum causing the fixing anchor to be swivelled automatically to the longitudinal axis of the tie bolt. For assembly the fixing anchor is rotated into a position flush with the longitudinal axis of the receiving hole so that the tie bolt, with the swivelled fixing anchor, can be pushed through the receiving hole; if the fixing anchor is released after passing through the hole, it automatically swivels into its locked position under the influence of its force of gravity. The tie bolt can then be shortened by screwing so that the fixing anchor is pulled from below against the lower surface of the fitting support, thus ensuring that the fitting body is clamped with the fixing anchor.

The disadvantage of a fixing of prior art designed in this manner for a stand fitting is that the structural design of the fixing anchor, including its fastening and mounting on the clamping nut, must be so accurate that automatic swivelling into the locked position is guaranteed, since after the tie bolt, with the fixing anchor mounted on it, is inserted in the receiving hole, it is no longer possible to correct the position of the fixing anchor. The manufacture and assembly of the fixing parts required for securing the fitting are correspondingly expensive.

A further disadvantage of the stand fitting disclosed in DE 93 05 513 A1 consists in the fact that the receiving hole, running perpendicularly, is only accessible from the top when the fitting body is inclined obliquely forward, as is also evident from the drawing representation in the above-mentioned publication. To this extent the design of corresponding stand fittings is subject to limitations.

The essential object of the invention is therefore to improve a stand fitting with associated fixing in a generic design so that the means of fixing are simpler to manufacture and fit, but are more reliable.

The achievement of this object, including advantageous embodiments and further developments of the invention, is evident from the content of the patent claims which follow this specification.

In its basic concept the invention provides that the fixing anchor is retained on the fitting body by means of an elongated, flexible spring that has a greater length the material thickness of the fitting support, and in that a threaded rod, supported on the fitting body, can be passed through a hole formed in the fitting body as a clamping device and can be screwed into a threaded hole formed on the fixing anchor with a thread formed at its end.

The advantage of the invention is that the connection of the fixing anchor to the fitting body can easily be made and pre-assembled by the spring, which is all that is required; since the spring need only guarantee the support of the fixing anchor and its movable arrangement relative to the fitting body, the spring is not subject to any special requirements. The manufacture and assembly of the clamping device that must then be fitted, in the form of the threaded rod, which is all that is required, do not impose any special requirements either, so that the cost of manufacture and assembly of the fixing device is considerably reduced. Nevertheless, the fixing arrangement is reliable because after the fixing anchor is inserted through the receiving hole of the fitting body, the spring serves to align the fixing anchor on the lower surface of the fitting support without this requiring a special alignment of the fixing anchor.

According to an exemplary embodiment of the invention the spring is designed as a helical spring. This provides the possibility, in an advantageous manner, for the threaded rod to run in the interior of the spring enclosed by spring coils, according to an exemplary embodiment of the invention, so that the spring represents a type of guide for insertion or screwing in of the threaded rod.

To enable the threaded rod to be clamped between the fitting body and the fixing anchor, provision is made for the threaded rod to be supported on the fitting body with a shoulder. For reasons of space provision can be made here for the hole in the fitting body to have a recess for receiving the shoulder of the threaded rod.

Alternatively provision may be made for the hole to have an inner thread and for the threaded rod to be screwed into the fitting body with an associated thread.

According to an exemplary embodiment provision is made, in terms of the design of the fixing anchor, for the fixing anchor to consist of a round basic body with a U-shaped section forming two outer lateral legs for receiving the small water connection pipes to be connected to the stand fitting; such a fixing anchor with a U-shaped section is disclosed, in principle, in DE 90 12 411 U1, but here the fixing anchor can only be fitted from the bottom of the fitting support.

For reasons of assembly provision is made, according to an exemplary embodiment of the invention, for the basic body of the fixing anchor to have a larger diameter than the diameter of the receiving hole, and for it to be provided with a flattened section running in the manner of a chord on the facing away from the section so that the fixing anchor fits into the receiving hole in the position bent in the longitudinal direction of the receiving hole.

An exemplary embodiment of the invention, which is described below, is shown in the drawing, where:

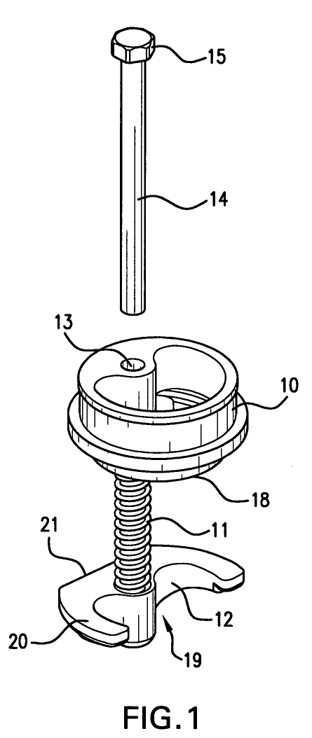

FIG. 1: shows a fitting body with a fitting anchor retained on it by means of a spring, including the threaded rod that can be subsequently inserted as a clamping device,

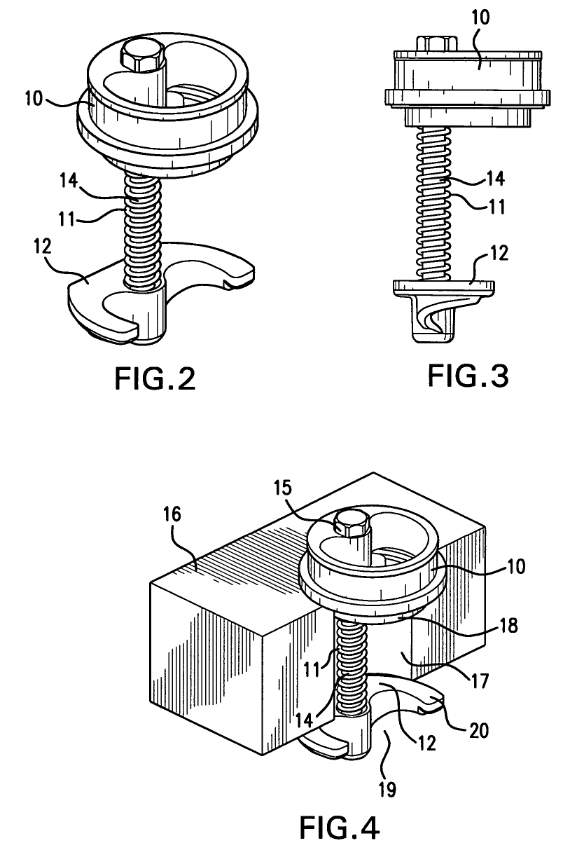

FIG. 2 shows the object of FIG. 1, with the threaded rod fitted,

FIG. 3 shows the object of FIG. 2, in side elevation,

FIG. 4 shows the object of FIG. 2, in a condition mounted on a fitting support,

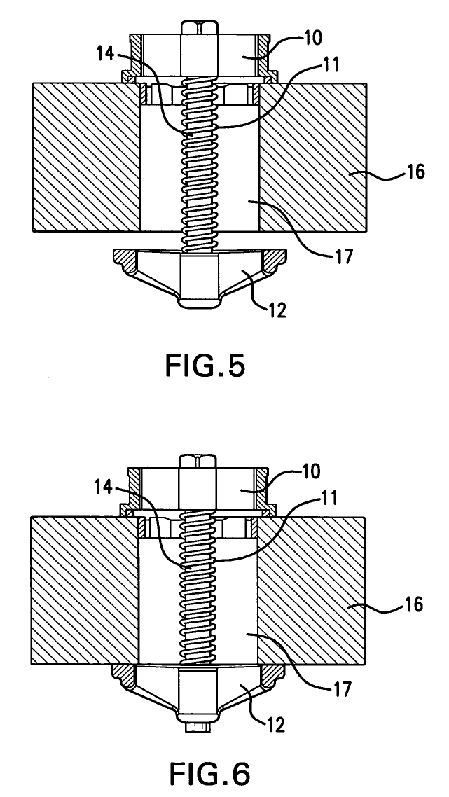

FIG. 5 shows the fitting body mounted on the fitting support, before the clamping device is clamped, in section,

FIG. 6 shows the object of FIG. 5, in the fully assembled condition, with the clamping device clamped.

As initially shown in FIG. 1, a fixing anchor 12 is retained on a fitting body 10 of a sanitary stand fitting of prior art, represented merely as a truncated body, by means of an inserted spring 11 designed as a helical spring, so that the fixing anchor 12 can be brought into any position relative to fitting body 10 due to the flexibility of spring 11. As will be explained later, a threaded rod can be inserted in a hole 13 formed in fitting body 10 so that threaded rod 14 runs in the interior enclose by the spring coils of spring 11, and can be screwed into a threaded hole formed at the base of spring 11 in fixing anchor 12.

This pre-assembled position is shown in FIGS. 2 and 3.

FIG. 4 shows the assembly of fitting body 10, with fixing anchor 12, on a fitting support 16, wherein this fitting support 16 may, for example, be the so-called bank of fittings of a wash-stand or sink, or of another sanitary appliance, or may also be formed from a kitchen worktop as a support plate for the stand fitting. A receiving hole 17 for the single-hole assembly of the stand fitting is formed in this fitting support 16.

As is evident from the overall view in FIGS. 5 and 6, fitting body 10 is mounted on fitting support 16 so that when the threaded rod has not yet been inserted fixing anchor 12 can be brought into a position flush with the longitudinal axis of receiving hole 17, due to the flexibility of spring 11, in which position fixing anchor 12 fits through receiving hole 17. When fitting body 10, with fixing anchor 12, is placed on fitting support 16, fitting body 10 is centred with a centring base 18 engaging in receiving hole 17.

If fixing anchor 12 is released from the receiving hole after being passed through it, spring 11 ensures that fixing anchor 12 is automatically aligned in its basic position in which fixing anchor 12 lies roughly parallel with the lower surface of fitting support 16. In this position threaded rod 14 is inserted in hole 13 of the fitting body and is screwed at its end into a threaded hole formed in fixing anchor 12; since the threaded rod is in this case supported on fitting body 10 with a shoulder 15 formed by a head, fixing anchor 12 is pulled in the direction of fitting body 10 by the rotation of threaded rod 14 to ensure mutual clamping of fixing anchor 12 and fitting body 10. Here the action of spring 11 offers sufficient resistance to the rotation of threaded rod 14 to prevent fixing anchor 12 from rotating with threaded rod 14; if fixing anchor then comes to rest on the lower surface of fitting support 16, the friction generated here also prevents co-rotation, so that threaded rod 14 can be sufficiently tightened on the fitting support to secure fitting body 10.

As disclosed in DE 9012 411 U1, fixing anchor 12 has an essentially round basic shape, wherein a U-shaped section 19, with the consequent formation of side legs 20, is formed from this round basic body thus formed; section 19 serves to receive the small water connection pipes to be connected to fitting body 10. In order to adapt the dimensions of the fixing anchor for insertion through receiving hole 17, and at the same time guarantee the safe retention of fixing anchor 12 on fitting support 16, the basic body of fixing body 12 has a larger diameter than the diameter of receiving hole 17, and is provided on its side facing away from section 19 with a flattened section 21 running in the manner of a chord, so that fixing anchor 12 fits into receiving hole 17 in the position bent in the longitudinal direction of receiving hole 17. After the fixing anchor is automatically aligned, side legs 20 project correspondingly from the edge of receiving hole 17 and ensure the secure fastening of fixing anchor 12 on the lower surface of fitting support 16.

The features of the object of the invention disclosed in the above specification, the patent claims, the abstract and the drawing, may be essential both individually and in any combinations for implementing the invention in its different embodiments.

1. A sanitary stand fitting for fixing in a receiving hole (17) of a fitting support (16), such as that of a sanitary appliance such as a wash-stand or sink or the like, or other support plate with a fixing anchor movably supported on the fitting body, which anchor, when the fitting body is assembled, can be brought into a position flush with the receiving hole of the fitting support, and can be guided through the receiving hole and automatically assumes a locked position after passing through the receiving hole, and with a clamping device by means of which the fitting body and the fixing anchor, in its locked position, are clamped against each other, characterised in that the fixing anchor (12) is retained on the fitting body (10) by means of an elongated flexible spring (11) having a greater length than the material thickness of the fitting support (16), and in that a threaded rod (14), as a clamping device, can be passed through a hole (13) formed in the fitting body (10) and can be screwed into a threaded hole formed on the fixing anchor with a thread formed at its end.

2. The stand fitting according to claim 1, characterised in that the spring (11) is designed as a helical spring.

3. The stand fitting according to claim 1, characterised in that the threaded rod (14) runs in the interior of the spring (1) enclosed by spring coils.

4. The stand fitting according to claim 1, characterised in that the threaded rod (14) is supported with a shoulder (15) on the fitting body (10).

5. The stand fitting according to claim 4, characterised in that the hole (13) has a recess for receiving the shoulder (15) of the threaded rod (14).

6. The stand fitting according to claim 1, characterised in that the hole (13) has a female thread and the threaded rod (14) can be screwed into the fitting body (10) with an associated thread.

7. The stand fitting according to claim 1, characterised in that the fixing anchor (12) comprises a round basic body with a U-shaped section (19), forming two outer side legs (20), for receiving small water connection pipes to be connected to the stand fitting.

8. The stand fitting according to claim 7, characterised in that the basic body of the fixing anchor (12) has a larger diameter than the diameter of the receiving hole (17), and is provided on the side facing away from the section (19) with a flattened section (21) running in the manner of a chord, so that the fixing anchor (12) fits into the receiving hole (17) in the position bent in the longitudinal direction of the receiving hole (17).
